(19) United States
(12) Patent Application Publication
(10) Pub. No.: US 2026/0004637 A1
(43) Pub. Date: Jan. 1, 2026

(54) GENERATING DATA FOR PLAYER BEHAVIOUR ANALYSIS

(71) Applicant: Aristocrat Technologies Australia PTY Limited, North Ryde (AU)

(72) Inventors: Andrew Wyllie, North Ryde (AU); Alan Wong, West Pennant Hills (AU); David Pickering, Peakhurst (AU); Jabez Allies, North Ryde (AU)

(21) Appl. No.: 19/247,433

(22) Filed: Jun. 24, 2025

(30) Foreign Application Priority Data
Jun. 27, 2024 (AU) 2024901961
May 16, 2025 (AU) 025203572

(51) Int. Cl. G07F 17/32; H04W 4/80

(52) U.S. Cl. CPC G07F 17/3239; G07F 17/323; H04W 4/80

(57) ABSTRACT

A technique for managing anonymous gaming session data includes obtaining an anonymous session data record and a corresponding device identifier. The device identifier is detected by performing a scan, from an electronic gaming machine and during an active gaming session, for nearby electronic devices. The device identifier is compared with one or more prior logged device identifiers associated with historic session data records to identify a matched device identifier. The technique identifies, from at least one of the historic data records having the matched device identifier, a user identifier. Moreover, the device modifies the anonymous session data record to include the user identifier.

### FIELD

The present application relates to a method and gaming system for generating data for player behavior analysis.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

Some EGMs are deployed in conjunction with player tracking systems, such as the OASIS® or System 7000® system manufactured by Aristocrat® Technologies, Inc with a player tracking interface deployed at the respective EGM, for example, in the form of a player marketing module or “console” to enable the player to enter a player loyalty card having an associated player identifier. When a player enters a loyalty card, a new gaming session is started that tracks play during the gaming session for the purpose of making player loyalty awards (e.g. an award of loyalty points). Some player tracking systems may enable a user to present a loyalty card by means of a card stored in a mobile device electronic wallet or to initiate a gaming session via a dedicated application (an “app”) running on the mobile device.

Where a player doesn't present a player loyalty card or equivalent, any gaming session on the EGM will be anonymous.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include in response to detecting initiation of a gaming session, monitoring, by an electronic gaming machine, the gaming session to generate first gaming session data, perform a scan for nearby electronic devices separate from the electronic gaming machine, and in response to detecting a nearby electronic device, recording a device identifier for the nearby electronic device. The method may also include in response to detecting, by the electronic gaming machine, termination of the gaming session, generating a session data record from the first gaming session data, and associate the session data record with the device identifier. Other embodiments of this aspect include corresponding computer systems, apparatus, and computer programs recorded on one or more computer storage devices, each configured to perform the actions of the methods.

In one general aspect, a non-transitory computer readable medium may include computer readable code to obtain an anonymous session data record and a corresponding device identifier. The computer readable code may also compare the device identifier with one or more prior logged device identifiers associated with historic session data records to identify a matched device identifier. The computer readable code may also identify, from at least one of the historic data records having the matched device identifier, a user identifier. The computer readable code may also modify the anonymous session data record to include the user identifier. Other embodiments of this aspect include corresponding computer systems, apparatus, and methods corresponding to the computer readable code.

In one general aspect, a gaming system may include one or more storage devices having a player event database. The gaming system may also include one or more processors. The gaming system may furthermore include one or more computer readable media having computer readable code executable by one or more processors to obtain an anonymous session data record and a corresponding device identifier, compare the device identifier with one or more prior logged device identifiers associated with historic session data records in the player event database to identify a matched device identifier, identify, from at least one of the historic data records having the matched device identifier, an user identifier, and modify the anonymous session data record to include the user identifier. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is an exemplary diagram showing several EGMs networked with various gaming related servers, according to one or more embodiments.

FIG. 2 is a block diagram showing various functional elements of an exemplary EGM, according to one or more embodiments.

FIG. 3 is a block diagram showing a network diagram, according to one or more embodiments.

FIG. 4 is a flow chart of a technique for collecting gaming session data, according to one or more embodiments.

FIG. 5 is a flowchart of a technique for recording gaming data and device identifiers, according to one or more embodiments.

FIG. 6 is a flowchart of a technique for matching anonymous session data records to known user identifiers, according to one or more embodiments.

FIG. 7 is a flowchart of a technique for performing behavioral analysis, according to one or more embodiments.

### DETAILED DESCRIPTION

Embodiments described herein relate to a system and method for improving the tracking of player activity in casino environments. In particular, by leveraging wireless communication technologies, the techniques described herein enable more accurate association of gaming sessions with individual players, even when traditional user identifiers are not presented.

In an example, embodiments are described where anonymous gaming session and identified gaming sessions are linked based on data that indicates they are conducted by a same player so that the player's behavior can be analyzed across the gaming sessions.

In some examples, players may unintentionally conduct an anonymous gaming session, for example, a player may forget to present a player loyalty card into a player interface module at an EGM when they start playing. If the player subsequently realizes this omission and presents their player loyalty card, player interface modules are configured such that a new gaming session will be initiated to track the player's play for loyalty purposes.

In other examples, a player may intentionally conduct an anonymous gaming session. For example, a player may not want an initial amount input to an EGM to be tracked by the loyalty system or may have a superstition related to player tracking such that they only want some of their play tracked for loyalty purposes. Such players may switch between anonymous and identified gaming sessions multiple times. From this example, it will be appreciated that in some examples, a player may start with an identified gaming session, and then switch to an anonymous gaming session. In such examples, a player may switch back to an identified gaming session, and may even repeatedly switch between identified and anonymous gaming sessions.

In other examples, a player may conduct an anonymous gaming session on one EGM and then conduct an identified gaming session on another EGM.

By linking gaming sessions together, embodiments of the invention enable the generation of richer data sets for behavioral analysis which, in turn, enables more relevant outputs from a behavioral analysis module.

In conventional casino player-tracking architectures, the loyalty system can associate player activity with a particular player only when the patron affirmatively presents a player identifier, such as inserting card into a card reader or logging in through a wallet application. If the patron omits, forgets, the resulting gaming session data are stored anonymously and remain disjoined from the player's historical record. This discontinuity affects downstream behavioral analytics. Existing reconciliation techniques are incapable of repairing the data gap because of the lack of correlation between the anonymous gaming session and the player.

The embodiments described herein provide technological improvement to the functioning of both the EGM and the casino management network by providing an on-machine wireless sensing and record fusion. In particular, the described techniques overcome prior deficiencies by embedding, within an electronic gaming machine (“EGM”), a dedicated communication module (e.g., a Bluetooth Low Energy transceiver) that continuously scans for proximate personal electronic devices during every wagering session. During an anonymous session, the player interface module executes a scanning routine at predefined intervals, captures each detected transceiver identifier, and records the transceiver identifier in real time to volatile memory, while gaming analytics are captured. Upon session termination, the session metrics and transceiver identifiers are aggregated into a session snapshot, and published to a player events database. Accordingly, the anonymous session is now tagged with one or more device-derived identifiers recorded during the session.

A server-side session processor then monitors incoming snapshots from networked EGMs and executes a matching algorithm that compares the stored transceiver identifiers of each anonymous session against the transceiver identifiers that accompany subsequently identified sessions. When a player later initiates a tracked session, their device's transceiver identifier is captured again and transmitted within the identified snapshot. Upon detecting a correspondence between a stored anonymous session transceiver identifier and the player's current transceiver identifier, the processor amends the prior anonymous record to incorporate the player identifier, merges the two snapshots under a common session key, and queues the enriched data set for behavioral analysis. This automated linkage yields a continuous, device-verified chronology of the patron's play across multiple EGMs, regardless of whether the patron explicitly engaged the loyalty system at every touchpoint.

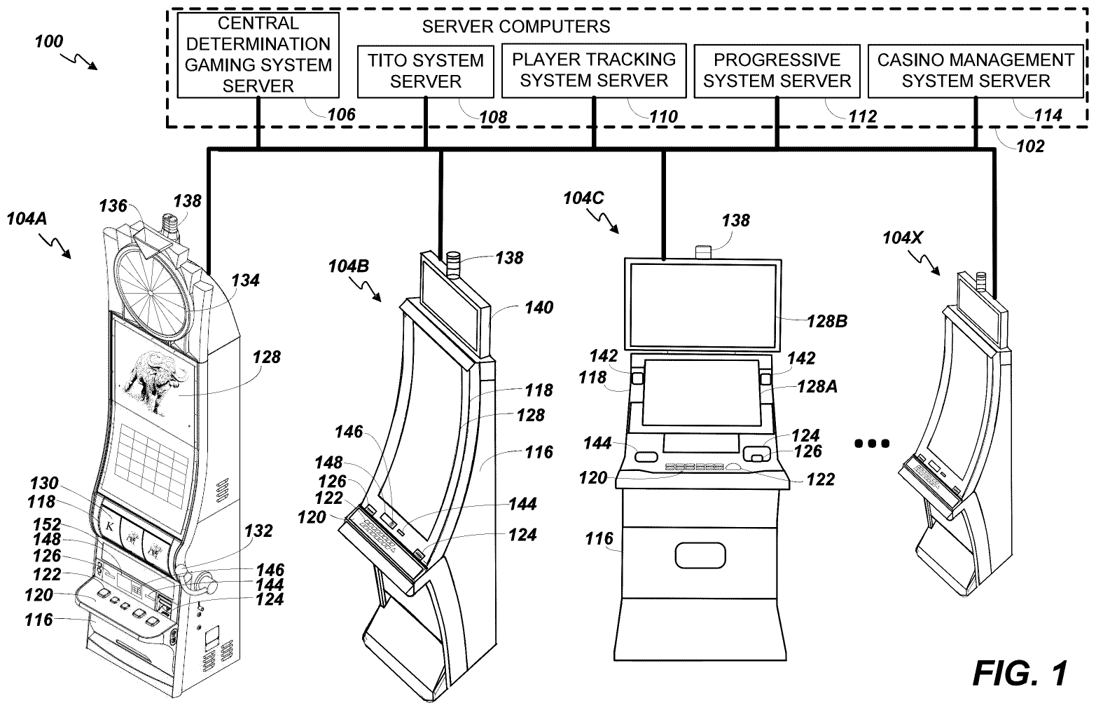

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or

OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card. In some other examples, a digital wallet can be used to store funds, such that funds can be transferred to and from the digital wallet. In some examples, an application on a user's mobile device (e.g. a cell phone) can communicate with the gaming device to transfer funds.

In some embodiments, a player tracking card reader 144, and/or a transceiver for wireless communication with a player's smartphone (e.g. for communicating with loyalty application or digital wallet application on the player's smartphone. In some embodiments, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

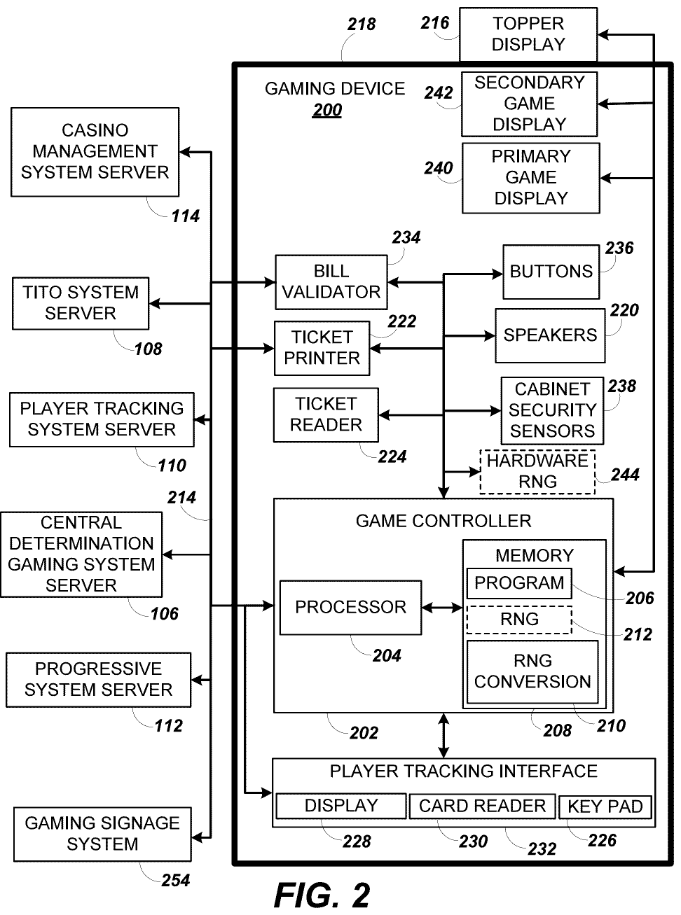

Many or all the above-described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® or System 7000® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash-out button to receive a ticket from the ticket printer 222). The ticket may be “cashed-in” for money or inserted into another machine to establish a credit balance for play.

In the above examples, the player tracking interface and TITO interfaces are described as being part of the EGM. In other implementations, a player interface module, sometimes referred to as a console, is provided separately to the EGM to implement this functionality. For example, to enable EGMs of many different manufacturers and ages to be integrated to a common system such as Aristocrat's Oasis® or System 7000 system. Such consoles may have the visual appearance of being integrated with EGMs by being fitted within casings designed to fit to the EGMs to which they are connected.

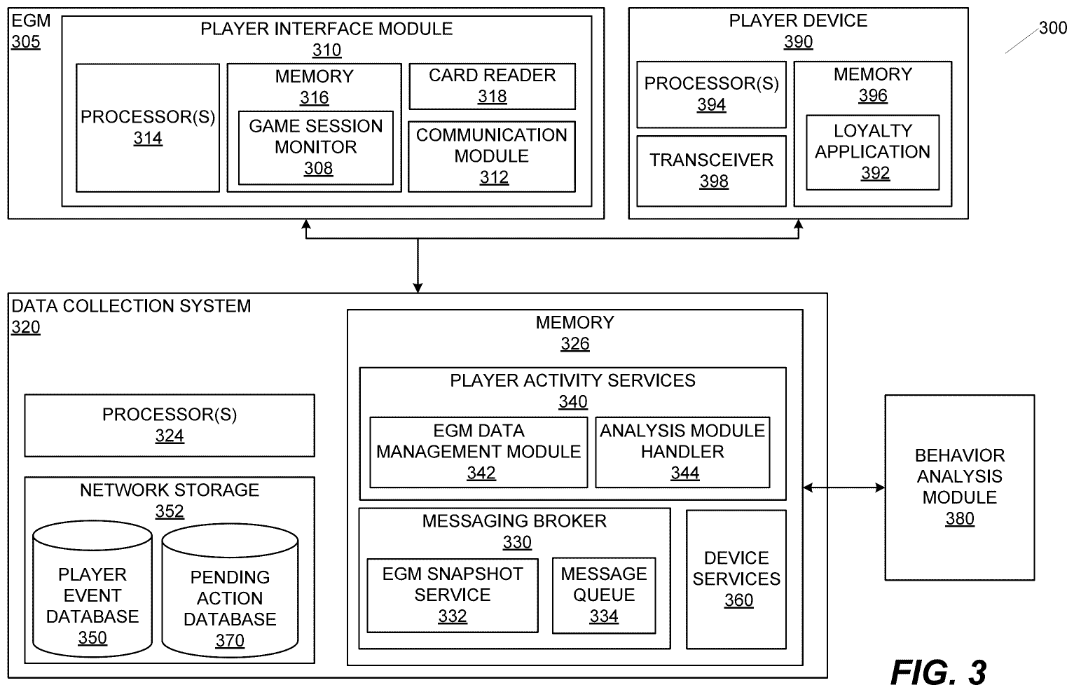

FIG. 3 is a block diagram 300 of an example system architecture which shows an example EGM 305 connected to a data collection system 320. It will be appreciated that in example embodiments, the data collection system 320 acts as a data collection server but this may be one of a number of functions performed by central server, for example, the data collection server 320 may be an integrated part of a player tracking system.

One EGM 305 is shown in FIG. 3 for illustrative purposes, however, it will be appreciated that the EGM 305 will be one of a number of EGMs at a venue. In some examples the EGMs 305 may be connected to the data collection system 320 by one or more front end processors (not shown).

In this example, each EGM 305 incorporates a player interface module 310 in data communication with the respective EGM 305 in order to monitor gaming events on the EGM. The player interface module 310 has its own one or more processor(s) 314 and one or more memory device(s) 316 storing program code that governs operation of the player interface module 310. Player interface module 310 also incorporates a card reader 318 for receiving a player card having a player identifier thereon and a ticket printer as described above. In other examples, player interface module 310 may include a communication module 312 (e.g. Bluetooth or NFC) for communicating with an electronic player device 390 (e.g. a cell phone or other mobile device) to obtain a player identifier. In other examples, other input devices such as a keyboard may be employed at the player interface module 310 to receive a player identifier.

The player interface module 310 monitors gaming sessions conducted on the EGM 305 and reports gaming session data to data collection system 320. The player interface module 310 initiates a new gaming session upon a player identifier being received or upon credit being established on the EGM 305 after the EGM 305 has been idle.

Data collection system 320 also comprises one or more processors 324 and memory 326 storing program code that governs operation of the data collection system 320. Executing the code implements a number of services within the system.

The services include a message broker 330 (e.g. RabbitMQ available from https://www.rabbitmq.com/) that implements a number of message services. A first message service is an EGM snapshot service 332 that receives gaming session data from respective EGMs 305 and places it in a first message queue 334 for processing. The gaming session data characterizes the gaming session (e.g. EGM identifier, amount spent, amount won, number of games, player identifier when available, etc.).

A player activity services module 340 includes an EGM data management module 342 that subscribes to the EGM snapshot service 332 of message broker 330 and processes each instance of session data, including by saving the data to a player events database 350 which is used to keep a state of each machine, derive EGM activities, track anonymous players, and to enable the linking of anonymous and identified gaming sessions.

In this respect, each time EGM data management module 342 receives gaming session data via its subscription to the EGM snapshot service 332, the EGM data management module 342 attempts to link it to a previous instance of gaming session data stored in player events database 350. In an example, EGM data management module 342 searches database 350 for any gaming sessions having at least one data element that corresponds to or matches one or more elements of the current instance of gaming session data. In an example, where the EGM data management module 342 is processing a current instance of gaming session data having an associated player identifier, EGM data management module 342 searches for an immediate prior gaming session on a same EGM based on an EGM identifier and determines whether an end credit balance for a gaming session matches a starting credit balance of the current gaming session. In some examples, EGM data management module 342 may also determine whether the immediate prior gaming session is within a defined time period.

In another example, where a gaming session includes a ticket identifier associated with a credit input event, the EGM data management module 342 searches for gaming session data having the same ticket identifier as an output event.

In some examples, the player interface module 310, may incorporate a communication module 312 (e.g. a Bluetooth or NFC module) for communication with player devices 390 in order to enable a user to use a loyalty application 392 running on their device 390 to interact with the player interface modules 310. For example, player device 390 may include one or more processor(s) 394, and memory 396, which includes computer readable code executable by processor(s) 394, such as loyalty application 392. In such examples, the player interface module 310 may use the communication module 312 to monitor (e.g. by repeated searching) for transceiver identifiers during a gaming session (e.g. Bluetooth identifiers) and keep a record of transceiver identifiers within range during a gaming session. For example, player device 390 may include a transceiver 398, such as a Bluetooth device or other device configured to transmit identifying information. It will be appreciated that other mobile device identifiers may be used to identify the presence of the mobile device. In some examples, the player interface module 310 may record transceiver identifiers in the gaming session data. In some examples, the player interface module 310 may record a subset of monitored transceiver identifiers based on one or more criteria. For example, the most frequently found transceiver identifier; each transceiver identifier found more than a defined number of times; each identifier meeting a duration criterion; or each identifier found in both a start time window corresponding to a start of the gaming session and an end time window corresponding to an end of the gaming session. The player interface module 310 may also be configured to exclude or filter out certain transceiver identifiers, for example, identifiers associated with other gaming components, such as other EGMs.

In some examples, a player may have a gaming application such as loyalty application 392 installed on an electronic device such as mobile device 390 that enables the user to provide a player identifier from their player device 390 to a player interface module 310 to initiate a tracked gaming session and the player interface module 310 may acquire the transceiver identifier from the communication connection in which the user provides the player identifier. In other examples, the loyalty application 392 may implements a wagering wallet executing on the player's electronic device and may enable a player to establish funds on an EGM, or modify the credit balance (e.g. by topping up the credit balance) by communicating with the player interface module 310, and the player interface module 310 may acquire the transceiver identifier from the communication connection in which the user establishes or modifies the credit balance. In another example, a player may provide a player identifier to the player interface module 310 some other way, such as by using a loyalty card read by card reader 318, and the player identifier may be used player interface module 310 to look up a transceiver identifier from a player record in a player database in cases where the transceiver identifier is stored in a player record or gaming session record.

If a player action, such as initiating tracked gaming session via their mobile device 390, enables a transceiver identifier to be associated with a gaming session, the player interface module 310 monitoring the tracked gaming session records the transceiver identifier as part of the gaming session data. This enables the EGM data management module 342 to search for prior anonymous gaming sessions having a same communication identifier.

Upon determining a correspondence between two gaming sessions, the anonymous gaming session data is modified to indicate it was conducted by the first player, whereby the first, previously anonymous, gaming session data and the second, identified, gaming session data can be used to analyse game play behavior of the first player. That is, an advantage of this embodiment is that a richer data set will be available, enabling improved outcomes from downstream processing of the data such as the ability to identify a behavior not identifiable from the identified data alone or to derive a behavior with a higher degree of certainty.

In an example, the EGM data management module 342 adds a unique session identifier to each instance of gaming session data. Once processed, EGM data management module 342 adds each set of gaming session data having an associated player identifier to a second queue in the form of a gaming session data queue maintained by messaging broker 330. That is, in this example, data is only sent to behavior analysis module when it corresponds to a player identifier.

In some examples, the first and second gaming session data sets may be formed into a common gaming session data set that replaces the first and second gaming session data in player events database 350. In an example, the common data set can be formed by EGM data management module updating the first gaming session data to incorporate data from the second gaming session data. In an example, EGM data management module 342 adds the updated first gaming session data to the gaming session data queue of messaging broker service 330. In another examples, the first and second gaming session data sets are stored separately and added to the gaming session data queue of messaging broker 330 separately.

Further, it will be appreciated that depending on player behavior there may be a subsequent anonymous gaming session that may be linked to these gaming sessions using a similar process. For example, in cases where a player chooses to switch between identified and unidentified gaming sessions. Indeed, while it is more common that a first gaming session is anonymous and a second gaming session is identified, a similar process may be used to attempt to link a first identified gaming session to a second subsequent anonymous gaming session. In such examples, upon receiving anonymous gaming session data, the EGM data management module 342 seeks to link it to a prior gaming session based on a correspondence between the two gaming sessions as exemplified above.

As shown in FIG. 3, player activity services module 340 incorporates an analysis module handler 344 that handles communications with the analysis module. In some examples, the analysis module handler 344 may be split into separate services that handle inbound and outbound communications.

In an example, the analysis module handler 344 subscribes to the gaming session data service of the messaging broker 330 so that when new (or updated) gaming session data is added to the queue, analysis module handler 344 can send it to behavior analysis module 380. In some examples, behavior analysis module 380 may be provided by a third party. In some examples, behavior analysis module 380 may be configured to process each instance of gaming session data in conjunction with historical data (which may include data for the identified player) to determine whether the gaming session data and any previously gathered data is indicative that the player has, or may be trending towards, engaging in an undesirable behavior. For example, that the player's gaming session data is indicative of behaviors that may lead to problem gambling. In some examples, behavior analysis module 380 may output behavior data identifying the player and defining a behavior message and/or behavior action based on the determination. In some examples, this enables a behavior message and/or behavior action to be identified earlier than would be the case based solely on identified gaming session data.

Behavior data instances output by behavior analysis module 380 are received by the analysis module handler 344 which places them into a message queue 334 managed by messaging broker 330.

Player device services module 360 is configured to communicate with a player's electronic device 390 (e.g. a cell phone) via an application 392 running on the mobile device, such as a loyalty application and/or a wagering wallet application. The player device services module 360 subscribes to the message queue 334 managed by messaging broker 330.

Upon a new behavior data instance being added to the message queue 334 of messaging broker 330, the device services module 360 retrieves the behavior data instance, and creates a record in pending action database 370 for tracking delivery of the behavior message and/or action to the player. Pending action database 370 and player event database 350 may be stored in network storage 352 across one or more storage devices, such as device storage, server storage, or the like.

In the example of a behavior message, player device services module 360 communicates the message to the loyalty application 392 on the player's mobile device 390 where it will be displayed to the user based on their device notification preferences. For example, the user might receive a notification that they have a new message and when they open the application, may see a message saying: “Time to take a break?”. In an example, once the user opens the message, the application 392 sends a message read notification to the device services module 360 which updates the pending action database 370 to remove the pending action because the message has been actioned. Device services module 360 also generates a feedback message and adds it to a feedback queue maintained by messaging broker 330. Analysis module handler 344 subscribes to the feedback queue and sends the feedback messages to behavior analysis module 380 for use in future analysis.

An example of a behavior action is creation of a time-limited voucher for delivery to a player engaged in a gaming session. In this example, upon receiving behavior data, device services module 360 creates a record in the pending action database 370 indicating that there is a pending voucher and starts a timer. In an example, device services module 360 also creates an entry for redemption of the voucher in a player loyalty database (not shown in FIG. 3). When the timer expires, device services module 360 conducts a check to determine whether the voucher has been redeemed, removes the record from the pending action database 370, generates a feedback message which encodes the outcome (redeemed/not redeemed) and adds it to a feedback queue maintained by messaging broker 330. Analysis module handler 344 subscribes to the feedback queue and sends the feedback messages to behavior analysis module 380 for use in future analysis.

Another example of a behavior action is a staff intervention, in which case, the device services module 360 creates a record in the manner described above and sends a message to a staff terminal for action and receives feedback from the staff terminal once actioned and generates a feedback message to add to the feedback queue.

In the above example, a user's mobile device is used to deliver messages via an application on the mobile device. In some examples, the player device services module 360 is modified to enable communication via different modes of communication and the system may determine the best method of communication—e.g. via mobile device, a kiosk, console, SMS, email, etc. In some examples, the system may adapt based on the feedback loop to ensure the best chance of a successful delivery and interaction with the player.

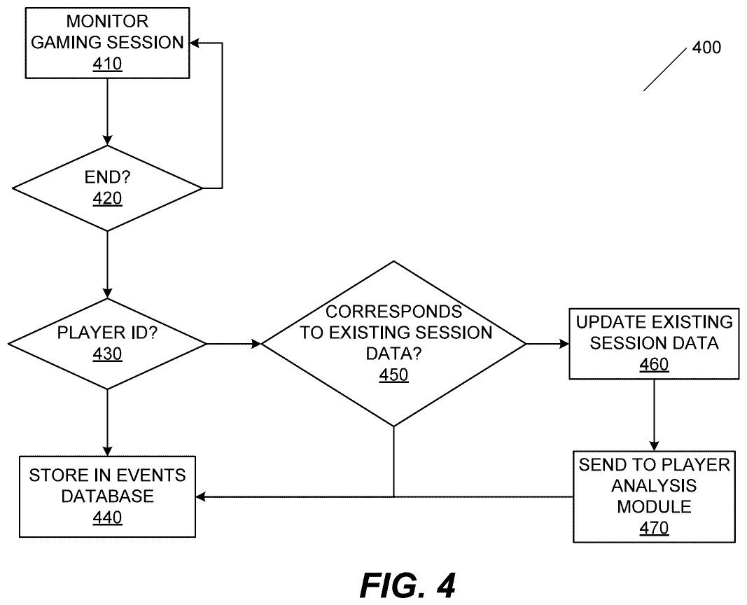

FIG. 4 is a flow chart of a method 400 of an example embodiment. At step 410, the method comprises monitoring a gaming session conducted at an EGM (e.g. with the player interface module) irrespective of whether the gaming session is identified (where a player identifier has been supplied at the beginning of the gaming session) or anonymous. The gaming session is monitored by, e.g. the player interface module, recording data about the gaming session such as amount wagered, number of games played, amount wagered per game, currency amounts input to the gaming machine, amount won, etc.

At step 420, the method involves monitoring for end of the gaming session, and while the gaming session has not been terminated (ended), continuing monitoring 410.

When it is determined at step 420 that a gaming session has ended (e.g. because a new gaming session has started), in one example, the method involves determining (e.g. at a sever), at step 430, whether a player identifier is attached to the gaming session. In this example, where there is no player identifier, the server stores 440 the gaming session data in a database.

When it is determined at step 430 that a player identifier is attached to a gaming session, at step 450, the server checks for correspondence with an existing anonymous instance of game session data at step 450. Upon making a positive determination at step 450, the server updates 460 the anonymous instance of gaming session data to indicate that it was conducted by the identified player. In some examples, this may involve updating 460 first gaming session data that was previously anonymous with second gaming session data gathered together with a player identifier after the first session was terminated such that the first and second gaming session data can be treated as a single gaming session conducted by the player identified from the second gaming session data.

In this way, anonymous gaming session data can be subsequently associated with a player so that a first gaming session with no identifier and second gaming session data that was identified by a player identifier can be collectively used to analyse behavior of the player.

After the data is updated, it may be sent 470 to the player analysis module 380 and the database 350 may be updated.

In another example, step 430 is removed and step 450 involves checking for correspondence with a previously stored gaming session data irrespective of whether a current gaming session is anonymous or identified.

It will be appreciated that method 400 may be conducted for a plurality of EGMs. In some examples, method 400 may seek to match data across EGMs, for example, based on a ticket identifier generated at the end of a gaming session at one EGM being presented at the start of a gaming session at another EGM.

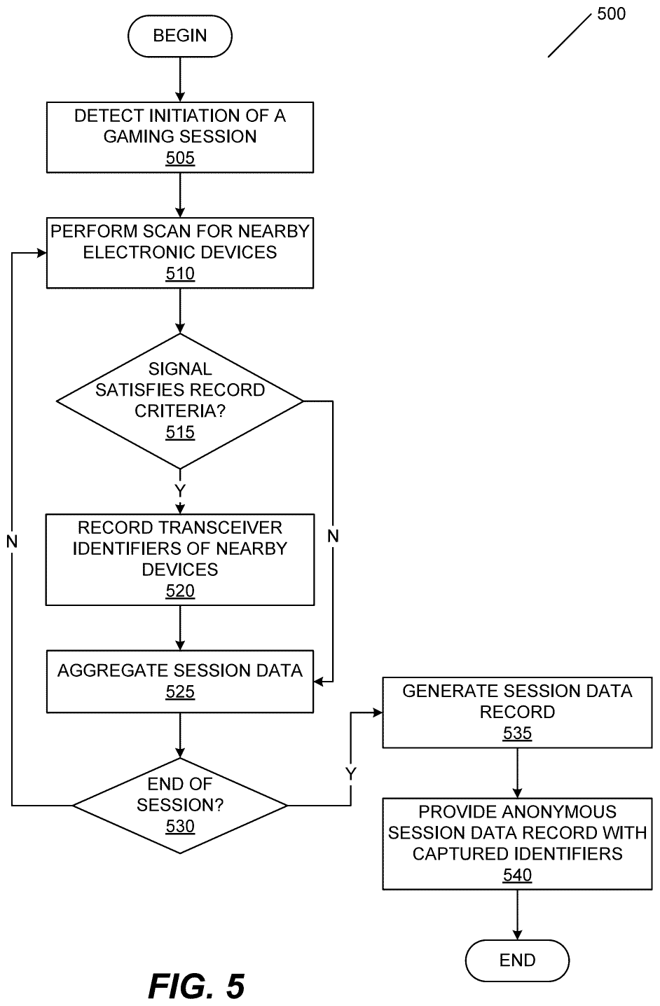

FIG. 5 illustrates a flowchart of a technique for creating an anonymous session data record that includes one or more wireless transceiver identifiers detected during an otherwise un-tracked gaming session. The flowchart is described in the context of the components described above with respect to FIG. 3. However, it should be understood that the various processes may be performed by alternative components. Further, although the processes are shown in a particular order, the various process may be performed in a different order or simultaneously, or some processes may be omitted or added according to one or more embodiments.

The flowchart 500 begins at block 505, where the initiation of a gaming session is detected. For example, a game session monitor 308 may evaluate a machine state to detect whether a user has engaged the machine in a gameplay session. In some embodiments, the game session monitor 308 may receive an indication of an initialized gameplay session. Alternatively, the game session monitor may occasionally or periodically request state data for the EGM to determine whether the EGM is active in a gameplay session.

The flowchart 500 proceeds to block 510, where the communication module 312 performs a scan for nearby electronic devices. In some embodiments, the communication module 312 may be activated in response to the detection of the initiation of the gaming session. The scan may be performed throughout an active gaming session, and may be performed continuously, occasionally, or periodically. The scan may be performed to detect transmissions from one or more nearby electronic device that advertises an identifier, such as a transceiver identifier, device identifier, or the like.

At block 515, a determination is made as to whether a detected signal satisfies a record criteria. For each identifier detected during the scan window, the technique involves evaluating the signal data for the identifier against one or more filter criteria maintained by a player event rules engine. Example parameters of the record criteria include a determination that the signal-strength above a configurable threshold (to exclude distant devices), a determination that the identifier not present on an ignore list of known infrastructure beacons, a metric of identifier persistence across successive scans, or the like.

If a determination is made that a signal satisfies the criteria, then the flowchart 500 proceeds to block 520, and identifiers satisfying the criteria may be time stamped and recorded to an in-session buffer in memory 316. The flowchart 500 proceeds to block 525 after the transceiver identifiers are recorded, or if a determination is made as to whether no signal satisfies the record criteria at block 515. At block 525, gaming session data is aggregated during the active gaming session. For example, session metrics may be captured by the game-session monitor 308, such as total amount wagered, total amount won, wager frequency, and session duration. The aggregation step also tags the data with the unique machine identifier of the hosting EGM 305 and with a locally generated session key that is unique within the events database 350.

The flowchart 500 proceeds to block 530, where a determination is made as to whether the session has ended. For example, the game session monitor 308 may check for an idle state condition defined by, for example, a zero credit balance persisting beyond a predetermined timeout or initiation of a tracked session by a subsequent player. If the session is still active, the flowchart 500 returns to block 510, and the process involves continuing to scan for nearby electronic devices, and aggregating session data until the end of the session is detected.

After the end of session, the flowchart 500 proceeds to block 535, where a session data record is generated. According to one or more embodiments, the session data is used to generate a structured session data record that complies with a schema used by the EGM snapshot service 332. The record may omit any player identifier fields, as the session was an anonymous session, but may embed, or be associated with, the recorded transceiver identifier.

The flowchart 500 concludes at block 540, where the anonymous session data record is provided with the captured identifier. According to one or more embodiments, the player interface module 310 transmits the record to the message broker 330, where the snapshot service 332 queues it for retrieval by the EGM data management module 342. The EGM data management module 342 will subsequently attempt to associate the anonymous record with a later identified session that includes the same transceiver identifier, as described above with reference to FIG. 3 and FIG. 4.

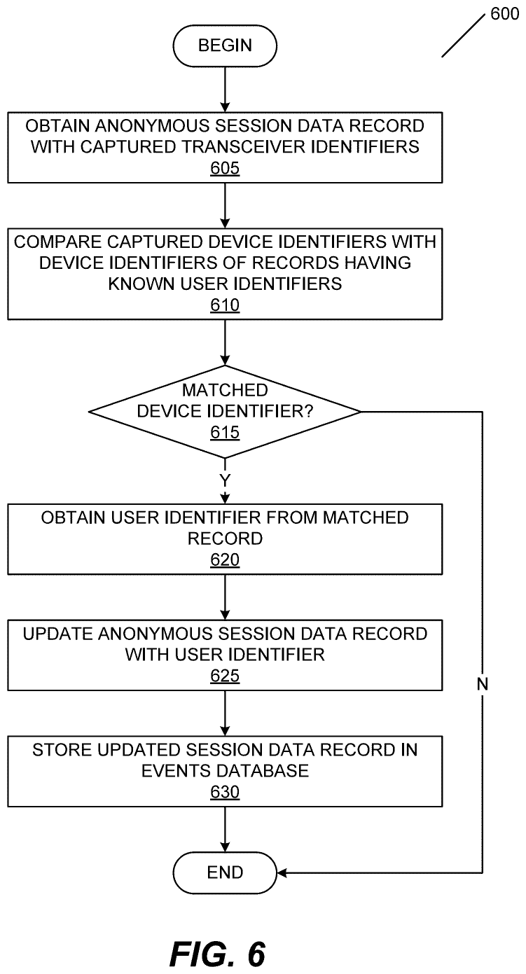

FIG. 6 is a flowchart of a technique for matching anonymous session data records to known user identifiers, according to one or more embodiments. The flowchart is described in the context of the components described above with respect to FIG. 3. However, it should be understood that the various processes may be performed by alternative components. Further, although the processes are shown in a particular order, the various process may be performed in a different order or simultaneously, or some processes may be omitted or added according to one or more embodiments.

The flowchart 600 begins at block 605, where the anonymous session data record is obtained, along with the captured transceiver identifiers. Upon activation, the EGM data management module 342 retrieves from the player events database 350 a gaming-session data record. In some embodiments, the anonymous session data record may lack a player identifier, but be associated with a device or transceiver identifier.

The flowchart 600 proceeds to block 610, where the captured device identifiers are compared with device identifiers of records having known user identifiers. The EGM data management module 342 conducts a comparison against a set of device identifiers already stored in the player events database 350 and associated with gaming session records that include an established player identifier. The comparison may be performed sequentially or in parallel and can employ direct equality, hash-based look-ups, or any other suitable matching algorithm.

A determination is made at block 615 as to whether a matched identifier is detected. If not, the flowchart concludes. If a matched identifier is detected at block 615, the flowchart 600 proceeds to block 620, and the user identifier is obtained from the matched record. The EGM data management module 342 extracts the player identifier from the matched, previously identified gaming-session record. The extracted player identifier may be, for example, a loyalty account number or other identifier, from the loyalty application 392.

The flowchart 600 proceeds to block 625, where the anonymous session data record is updated with the user identifier. The EGM data management module 342 amends the anonymous session record by inserting the extracted player identifier into the appropriate data field. Optionally, the processor adds a link or annotation indicating the source of the player identifier and/or the time of the association.

The flowchart 600 concludes at block 630, where the updated session data record is stored in the events database. Because the record now contains a player identifier, the EGM data management module 342 also publishes the updated session record to the appropriate message queue managed by the messaging broker 330, enabling subsequent behavioral analysis by the behavior analysis module 380 and permitting notifications or other downstream actions to be initiated.

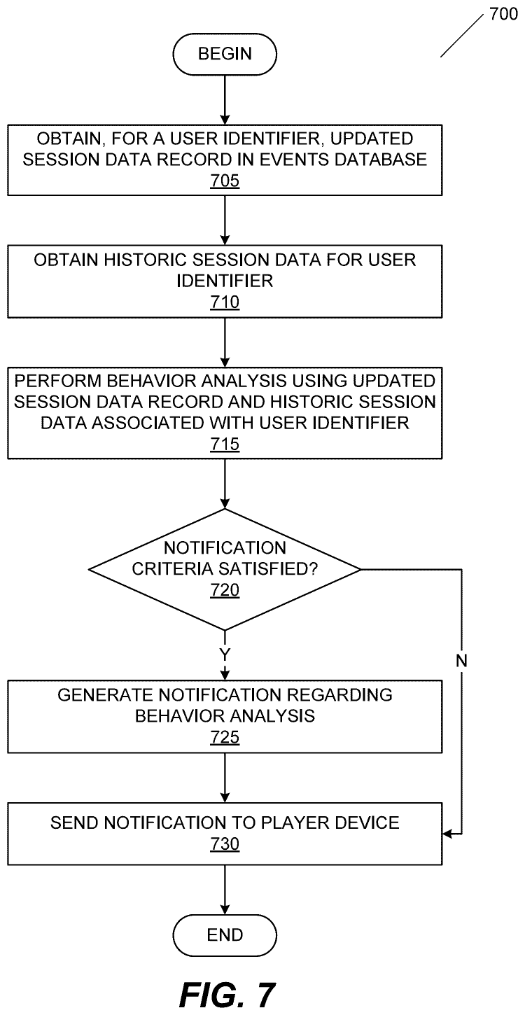

FIG. 7 is a flowchart of a technique for performing behavioral analysis, according to one or more embodiments. The flowchart is described in the context of the components described above with respect to FIG. 3. However, it should be understood that the various processes may be performed by alternative components. Further, although the processes are shown in a particular order, the various process may be performed in a different order or simultaneously, or some processes may be omitted or added according to one or more embodiments.

The flowchart 700 begins at block 705, where the updated session data record is obtained from an events database. According to one or more embodiments, the analysis module handler 344 detects, e.g. by subscribing to a queue of the messaging broker 330, that a new or updated gaming session data record has been committed to the player events database 350. The analysis module handler 344 therefore initiates the behavioral analysis sequence shown in accordance with one or more embodiments. Retrieval may be performed by a direct database query keyed on the user identifier or by reading the payload of the queue entry delivered by the messaging broker 330.

At block 710, historic session data is obtained for the user identifier. According to one or more embodiments, the analysis module handler 344 next retrieves historic session data for the same user identifier from the player events database 350. As an example, the handler 344 calls a stored procedure that returns all prior session records associated with the user identifier or, alternatively, a bounded set of historic records that satisfy one or more recency or relevance criteria.

The flowchart proceeds to block 715, where a behavior analysis is performed using updated session data record and the historic session data associated with the user identifier. In some embodiments, the analysis module handler 344 passes both the updated session data record acquired at block 705 and the historic session data retrieved at block 710 to the behavior analysis module 380. The behavior analysis module 380 executes one or more analytical routines, such as time-series analysis, threshold comparisons, predictive modelling, or pattern-recognition algorithms, to determine whether the combined data is satisfies a criteria of a behavior of interest. Such behaviors may include, among others, session frequency escalation, sharp increases in average bet size, prolonged continuous play, or other patterns associated with heightened risk, promotional eligibility, or other operationally significant events.

A determination is made a block 720 as to whether a notification criteria is satisfied. The notification criteria may be based on the behavior criteria being satisfied, a combination of criteria being satisfied, or the like. For example, in some embodiments, a temporal trend of the behavior analytics may be determined to satisfy a notification criteria. If the notification criteria is not satisfied, the flowchart concludes.

If the notification criteria is satisfied, the flowchart proceeds to block 725. At block 725, a notification is generated regarding the behavior analysis. According to one or more embodiments, the analysis module handler 344 generates a notification payload that describes the outcome of the behavior analysis. The payload may embed the user identifier, a notification type code, and/or metadata sufficient to permit downstream components to select the appropriate communication channel and message template. According to one or more embodiments, the notification payload is queued on a designated outbound queue maintained by the messaging broker 330.

The flowchart concludes at block 730, where the notification is sent to the player device. For example, the player device services module 360, which subscribes to the outbound notification queue, may retrieve the payload, record an entry in the pending action database 370 to enable delivery tracking, and transmits a corresponding notification to the player's electronic device 390. Transmission may occur via a communication connection established between the communication module 312 of the player interface module 310 and the loyalty application 392 executing on the device 390, or via any alternative delivery mechanism selected by the player device services module 360.

The invention may be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A method of generating data for player behavior analysis, the method comprising:
in response to detecting initiation of a gaming session:
monitoring, by an electronic gaming machine, the gaming session to generate first gaming session data,
perform a scan for nearby electronic devices separate from the electronic gaming machine, and
in response to detecting a nearby electronic device, recording a device identifier for the nearby electronic device; and
in response to detecting, by the electronic gaming machine, termination of the gaming session:
generate a session data record from the first gaming session data, and
associate the session data record with the device identifier.

2. The method of claim 1, further comprising:
providing the session data record and the device identifier for performing a matching process between the device identifier and a prior recorded device identifier from a historic session data record having a user identifier.

3. The method of claim 1, wherein the gaming session is an anonymous gaming session.

4. The method of claim 1, wherein performing the scan comprises detecting transceiver data from the nearby electronic device, and wherein the device identifier is recorded of the nearby electronic device further in response to a determination that the transceiver data satisfies a record criteria.

5. The method of claim 4, further comprising:
detecting additional transceiver data from an additional electronic device; and
applying a filtering process to the nearby electronic device and the additional electronic device,
wherein the device identifier is recorded based on the filtering process.

6. The method of claim 4, wherein the scan is performed in accordance with a communication connection between the nearby electronic device and the electronic gaming machine.

7. The method of claim 1, wherein the device identifier comprises a Bluetooth identifier.

8. A non-transitory computer readable medium comprising computer readable code executable by one or more processors to:
obtain an anonymous session data record and a corresponding device identifier;
compare the device identifier with one or more prior logged device identifiers associated with historic data records to identify a matched device identifier;
identify, from at least one of the historic data records having the matched device identifier, a user identifier; and
modify the anonymous session data record to include the user identifier.

9. The non-transitory computer readable medium of claim 8, further comprising computer readable code to:
apply the modified anonymous session data and the at least one of the historic data records to a behavior analysis process; and
in response to the behavior analysis process indicating that the modified anonymous session data and the at least one of the historic data records satisfies a notification criteria, generate a user notification.

10. The non-transitory computer readable medium of claim 9, wherein the notification criteria is satisfied by the modified anonymous session data without consideration of the at least one of the historic data records.

11. The non-transitory computer readable medium of claim 9, wherein the notification criteria is satisfied by a temporal trend based on the modified anonymous session data and the at least one of the historic data records.

12. The non-transitory computer readable medium of claim 9, further comprising computer readable code to:
transmit the user notification to a device associated with the device identifier.

13. The non-transitory computer readable medium of claim 8, wherein the anonymous session data is collected from a first electronic gaming machine, and wherein the at least one of the historic data records are collected from a second electronic gaming machine.

14. A gaming system comprising:
one or more storage devices comprising a player event database; and
one or more processors; and
one or more computer readable media comprising computer readable code executable by one or more processors to:
obtain an anonymous session data record and a corresponding device identifier;
compare the device identifier with one or more prior logged device identifiers associated with historic session data records in the player event database to identify a matched device identifier;
identify, from at least one of the historic data records having the matched device identifier, a user identifier; and
modify the anonymous session data record to include the user identifier.

15. The gaming system of claim 14, further comprising computer readable code to:
apply the modified anonymous session data and the at least one of the historic data records to a behavior analysis process; and
in response to the behavior analysis process indicating that the modified anonymous session data and the at least one of the historic data records satisfies a notification criteria, generate a user notification.

16. The gaming system of claim 15, wherein the notification criteria is satisfied by the modified anonymous session data without consideration of the at least one of the historic data records.

17. The gaming system of claim 15, wherein the notification criteria is satisfied by a temporal trend based on the modified anonymous session data and the at least one of the historic data records.

18. The gaming system of claim 15, further comprising computer readable code to:
transmit the user notification to a device associated with the device identifier.

19. The gaming system of claim 14, wherein the anonymous session data is collected from a first electronic gaming machine, and wherein the at least one of the historic data records are collected from a second electronic gaming machine.

20. The gaming system as claimed in claim 14, further comprising computer readable code to:
place, by a broker service, each received instance of gaming session data generated by an electronic gaming machine in a first message queue;
subscribe, by a data management module, to the first message queue; and
save, by the data management module, each instance of gaming session data to the player events database.
